(19) United States
(12) Patent Application Publication
(10) Pub. No.: US 2017/0255071 A1
(43) Pub. Date: Sep. 7, 2017

(54) ARRAY SUBSTRATE AND IN-PLANE SWITCHING LIQUID CRYSTAL DISPLAY PANEL

(71) Applicant: AU Optronics Corporation, Hsin-Chu (TW)

(72) Inventors: Yu-Ling YEH, Hsin-Chu (TW); Pei-Chun Liao, Hsin-Chu (TW); Chun-Ru Huang, Hsin-Chu (TW)

(21) Appl. No.: 15/370,057

(22) Filed: Dec. 6, 2016

(30) Foreign Application Priority Data
Mar. 4, 2016 (TW) 105106660

(51) Int. Cl. G02F 1/1362; G02F 1/1343

(52) U.S. Cl. CPC G02F 1/136209; G02F 1/13439; G02F 1/136286; G02F 1/134363; G02F 2001/134318; G02F 2201/123; G02F 2201/121

(57) ABSTRACT

An array substrate includes a substrate, data lines, gate lines, at least one pixel electrode, at least one common electrode, at least one light-shielding pattern, and at least one auxiliary electrode. At least one pixel region is defined by the data lines and the gate lines disposed and crossing with one another on the substrate. The pixel electrode, the common electrode, the light-shielding pattern, and the auxiliary electrode are disposed on the substrate and at least partially located in the pixel region. The pixel electrode includes at least one first branch electrode, and the common electrode includes at least one second branch electrode. The first branch electrode and the second branch electrode are disposed alternately in a first direction. The light-shielding pattern is disposed between a data line adjacent to the pixel region and the first branch electrode in the first direction. The auxiliary electrode is at least partially located between the first branch electrode and the light-shielding pattern in the first direction, and the auxiliary electrode is electrically connected to the pixel electrode.

### BACKGROUND

Technical Field

The present invention relates to an array substrate and an in-plane switching (IPS) liquid crystal display panel, and in particular, to an array substrate and an IPS liquid crystal display panel in which an auxiliary electrode having a level the same as that of a pixel electrode is further disposed between the pixel electrode and a light-shielding pattern to mitigate a crosstalk phenomenon.

Related Art

With the ongoing development of liquid crystal display technologies, liquid crystal display panels have found wide application in flat-screen televisions, notebook computers, mobile phones and various types of consumer electronic products. To resolve a disadvantage of an excessively small viewing angle of a conventional liquid crystal display, in the industry, an IPS liquid crystal display is developed, of which a main feature is that a common electrode and a pixel electrode are both disposed on an array substrate, and electric fields in a horizontal direction that are generated by the common electrode and the pixel electrode are used to drive arrangement of liquid crystal molecules, thereby achieving a wide-viewing-angle effect. However, under the premise of the design to maximize a pixel aperture ratio, horizontal electric fields of adjacent pixel regions easily affect each other and cause a crosstalk phenomenon, resulting in adverse impact on a display effect.

### SUMMARY

A main objective of the present invention is to provide an array substrate and an IPS liquid crystal display panel, in which an auxiliary electrode that is disposed between a pixel electrode and a light-shielding pattern and has a level same as that of the pixel electrode is used to mitigate a crosstalk phenomenon and further improve display quality.

To achieve the foregoing objective, an embodiment of the present invention provides an array substrate, including a substrate, a plurality of data lines, a plurality of gate lines, at least one pixel electrode, at least one common electrode, at least one light-shielding pattern, and at least one auxiliary electrode. The data lines and the gate lines are disposed on the substrate, and at least one pixel region is defined by the data lines and the gate lines crossing with one another. The pixel electrode, the common electrode, the light-shielding pattern, and the auxiliary electrode are disposed on the substrate and are at least partially located in the pixel region. The pixel electrode includes at least one first branch electrode, the common electrode includes at least one second branch electrode, and the first branch electrode and the second branch electrode are disposed alternately in a first direction. The light-shielding pattern is disposed between a data line adjacent to the pixel region and the first branch electrode in the first direction. The auxiliary electrode is at least partially located between the first branch electrode and the light-shielding pattern in the first direction, and the auxiliary electrode is electrically connected to the pixel electrode.

To achieve the foregoing objective, another embodiment of the present invention provides an IPS liquid crystal display panel, including an array substrate, an opposite substrate, and a liquid crystal layer. The opposite substrate and the array substrate are disposed opposite, and the liquid crystal layer is disposed between the array substrate and the opposite substrate. The array substrate includes a substrate, a plurality of data lines, a plurality of gate lines, at least one pixel electrode, at least one common electrode, at least one light-shielding pattern, and at least one auxiliary electrode. The data lines and the gate lines are disposed on the substrate, and at least one pixel region is defined by the data lines and the gate lines crossing with one another. The pixel electrode, the common electrode, the light-shielding pattern, and the auxiliary electrode are disposed on the substrate and are at least partially located in the pixel region. The pixel electrode includes at least one first branch electrode, the common electrode includes at least one second branch electrode, and the first branch electrode and the second branch electrode are disposed alternately in a first direction. The light-shielding pattern is disposed between a data line adjacent to the pixel region and the first branch electrode in the first direction. The auxiliary electrode is at least partially located between the first branch electrode and the light-shielding pattern in the first direction, and the auxiliary electrode is electrically connected to the pixel electrode.

### BRIEF DESCRIPTION OF THE DRAWINGS

FIG. 1 is a schematic view of an array substrate according to a first embodiment of the present invention;

FIG. 2 is a schematic sectional view drawn along a sectional line A-A′ in FIG. 1;

FIG. 3 shows an IPS liquid crystal display panel according to the first embodiment of the present invention;

FIG. 4 is a diagram of brightness distribution of pixel regions on two sides of a data line of the IPS liquid crystal display panel according to the first embodiment of the present invention;

FIG. 5 is a diagram of brightness distribution of pixel regions on two sides of a data line of an IPS liquid crystal display panel according to a first comparison example of the present invention;

FIG. 6 is a diagram of brightness distribution of pixel regions on two sides of a data line of an IPS liquid crystal display panel according to a second comparison example of the present invention;

FIG. 7 is a schematic view of an array substrate and an IPS liquid crystal display panel according to a second embodiment of the present invention;

FIG. 8 is a schematic view of an array substrate and an IPS liquid crystal display panel according to a third embodiment of the present invention;

FIG. 9 is a schematic view of an array substrate and an IPS liquid crystal display panel according to a fourth embodiment of the present invention; and

FIG. 10 is a schematic view of an array substrate and an IPS liquid crystal display panel according to a fifth embodiment of the present invention.

### DETAILED DESCRIPTION

To make a person of ordinary skill in the technical field of the present invention further understand the present invention, the formation content and the efficacy to achieve of the present invention are described below in detail with reference to the preferred embodiments of the present invention and the accompanying drawings.

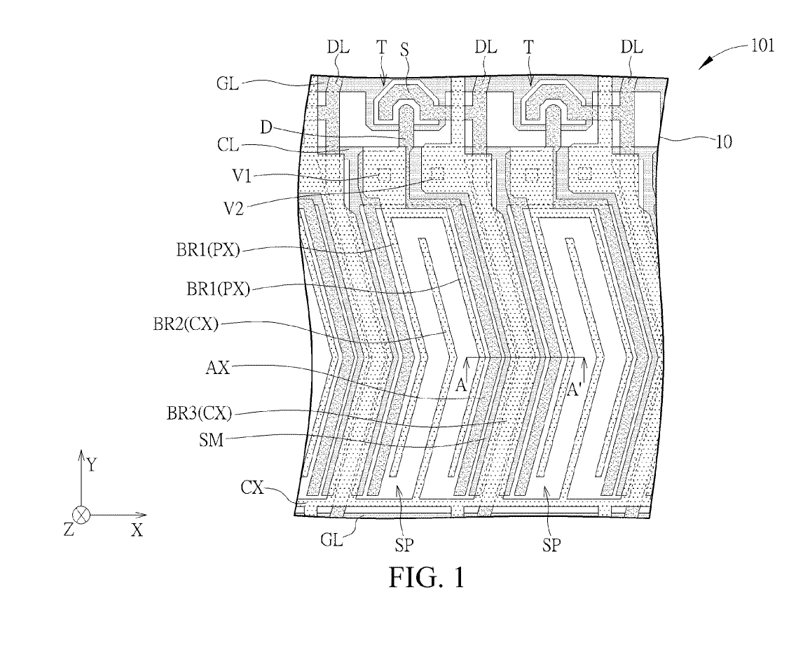

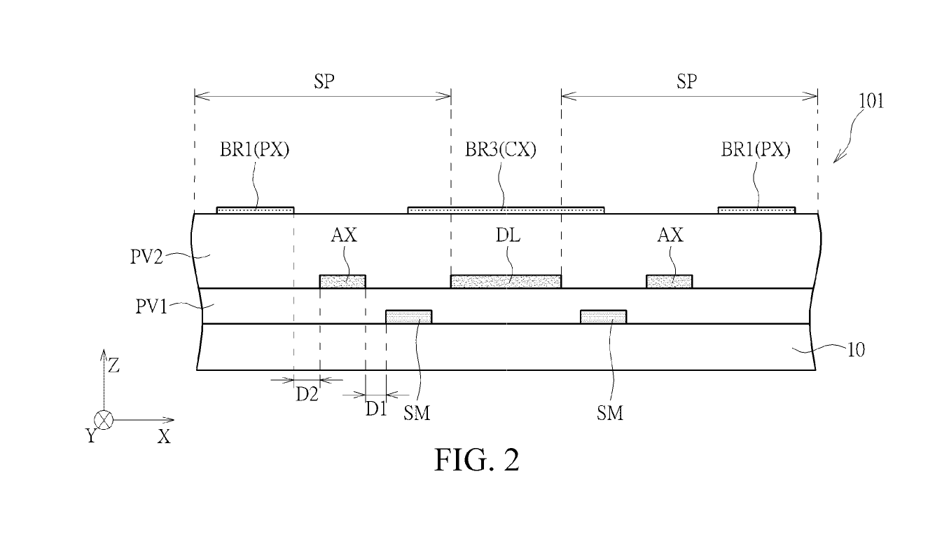

Refer to FIG. 1 and FIG. 2. FIG. 1 is a schematic view of an array substrate according to a first embodiment of the present invention. FIG. 2 is a schematic sectional view drawn along a sectional line A-A′ in FIG. 1. For ease of description, the accompanying drawings of the present invention are only exemplary to make it easier to understand the present invention, and specific proportions in the accompanying drawings can be adjusted according to a design requirement. As shown in FIG. 1 and FIG. 2, this embodiment provides an array substrate 101, including a substrate 10, a plurality of data lines DL, a plurality of gate lines GL, at least one pixel electrode PX, at least one common electrode CX, at least one light-shielding pattern SM, and at least one auxiliary electrode AX. The data lines DL and the gate lines GL are disposed on the substrate 10, and at least one pixel region SP is defined by the data lines DL and the gate lines GL crossing with one another. The pixel electrode PX, the common electrode CX, the light-shielding pattern SM, and the auxiliary electrode AX are disposed on the substrate 10 and are at least partially located in the pixel region SP. It should be further described that, in this embodiment, a plurality of pixel regions SP is defined by the data lines DL and the gate lines GL crossing with one another, and the array substrate 101 includes a plurality of pixel electrodes PX, a plurality of common electrodes CX, a plurality of light-shielding patterns SM, and a plurality of auxiliary electrodes AX that are disposed in the corresponding pixel region SP respectively. At least one pixel electrode PX, at least one common electrode CX, at least one light-shielding pattern SM, and at least one auxiliary electrode AX are disposed in each pixel region SP. In each pixel region SP, the pixel electrode PX includes at least one first branch electrode BR1, the common electrode CX includes at least one second branch electrode BR2, and the first branch electrode BR1 and the second branch electrode BR2 are disposed alternately in a first direction X. The light-shielding pattern SM is disposed in the first direction X between a data line DL adjacent to the pixel region SP corresponding to the light-shielding pattern SM and the first branch electrode BR1 located in a same pixel region SP. The auxiliary electrode AX is at least partially located in the first direction X between the first branch electrode BR1 and the light-shielding pattern SM in a same pixel region SP, and the auxiliary electrode AX is electrically connected to the pixel electrode PX. By making the auxiliary electrode AX and the pixel electrode PX have equal levels, a crosstalk phenomenon caused by a strong electric field caused between the pixel electrodes PX and the common electrodes CX in adjacent pixel regions SP can be mitigated. For example, if the first direction X in which the gate lines GL extend is defined as a row direction, and a second direction Y in which the data lines DL extend is defined as a column direction. During driving by using column inversion, if the auxiliary electrode AX in this embodiment is not disposed, when two adjacent pixel regions SP in the first direction X are respectively driven by using different polarities, a vertical crosstalk (V-crosstalk) phenomenon occurs easily, while the auxiliary electrode AX in this embodiment can be used to mitigate such a crosstalk phenomenon.

It should be further described that, as shown in FIG. 1 and FIG. 2, in this embodiment, in a same pixel region SP, the pixel electrode PX is on a same plane as the common electrode CX, the light-shielding pattern SM is not on a same plane as the pixel electrode PX, and the auxiliary electrode AX is on a same plane as the pixel electrode PX and the light-shielding pattern SM. For example, the substrate 10 in this embodiment may include a rigid substrate such as a glass substrate and a ceramic substrate or a flexible substrate such as a plastic substrate or a substrate made of another suitable material. The light-shielding pattern SM may be formed on the substrate 10 by using a first patterning metal layer, and a first dielectric layer PV1 is then formed covering the substrate 10 and the light-shielding pattern SM. Next, the data lines DL and the auxiliary electrode AX are formed on the first dielectric layer PV1. Therefore, the auxiliary electrode AX may be on a same plane as the data lines DL, and the auxiliary electrode AX and the data lines DL may also be formed by using a same conductive layer (for example, a second patterning metal layer); however, the present invention is not limited thereto. Subsequently, a second dielectric layer PV2 is formed covering the auxiliary electrode AX, the data lines DL, and the first dielectric layer PV1, and the pixel electrode PX and the common electrode CX are formed on the second dielectric layer PV2. The foregoing first patterning metal layer and second patterning metal layer may respectively include a metal material such as at least one of aluminum, copper, silver, chromium, titanium, and molybdenum, a composite layer of the foregoing materials or an alloy of the foregoing materials, but are not limited thereto. In other words, the auxiliary electrode AX in this embodiment may include a metal material, but the present invention and is not limited thereto. In another embodiment of the present invention, a transparent conductive material may also be used to form the auxiliary electrode AX according to a requirement, thereby achieving an effect of increasing an aperture ratio of the pixel region SP. In addition, the pixel electrode PX and the common electrode CX may preferably include a patterning transparent conductive layer, and this patterning transparent conductive layer may include indium tin oxide (ITO), indium zinc oxide (IZO), aluminum zinc oxide (AZO) or another suitable transparent conductive material.

The array substrate 101 in this embodiment further includes at least one control element T disposed on the substrate 10 and at least partially located in the pixel region SP. The pixel electrode PX and the auxiliary electrode AX are respectively electrically connected to a drain D of the control element T to have the same level. For example, the auxiliary electrode AX, the data lines DL, and a source S and the drain D of the control element T may be formed by using a same patterning conductive layer. The pixel electrode PX may be electrically connected to the drain D via a first contact hole V1, and the auxiliary electrode AX may be directly connected to the drain D, so that the pixel electrode PX and the auxiliary electrode AX may be electrically connected to have the same level; however, the present invention is not limited thereto. In another embodiment of the present invention, the pixel electrode PX and the auxiliary electrode AX may also be electrically connected in another lamination manner or/and a bridging design to have the same level. It should be noted that the foregoing level of the pixel electrode PX refers to a level maintained after the pixel electrode PX of the pixel region SP is turned on by the control element T.

In addition, in this embodiment, at least a part of the auxiliary electrode AX is preferably not overlapped with the pixel electrode PX or/and the light-shielding pattern SM in a vertical direction Z of the substrate 10; however, the present invention is not limited thereto. In another embodiment of the present invention, the auxiliary electrode AX may also be made partially overlapped with the pixel electrode PX or/and the light-shielding pattern SM according to a requirement, so as to increase an aperture ratio of the pixel region SP. In other words, it only needs to be avoided that the auxiliary electrode AX is directly disposed right below or right above the pixel electrode PX and that the auxiliary electrode AX is directly disposed right below or right above the light-shielding pattern SM to ensure an effect of mitigating a crosstalk condition of the auxiliary electrode AX. In addition, the light-shielding pattern SM in this embodiment may also be electrically connected to the common electrode CX. For example, the light-shielding pattern SM and a common line CL may be formed by using a first patterning metal layer, and the common electrode CX may be electrically connected to the common line CL via a second contact hole V2; however, the present invention is not limited thereto. In another embodiment of the present invention, the common electrode CX, the common line CL, and the light-shielding pattern SM may also be electrically connected to each other in another lamination manner or/and a bridging design. In addition, the common electrode CX may further include a third branch electrode BR3 disposed corresponding to a data line DL adjacent to the pixel region SP corresponding to this common electrode CX, and the third branch electrode BR3 is partially overlapped with the data line DL in the vertical direction Z of the substrate 10.

As shown in FIG. 1 and FIG. 2, a distance (for example, a first distance D1 shown in FIG. 2) of the auxiliary electrode AX in the first direction X from the light-shielding pattern SM is preferably less than a distance (for example, a second distance D2 shown in FIG. 2) of the auxiliary electrode AX in the first direction X from the first branch electrode BR1, so that an effect of reducing, by the auxiliary electrode AX, a crosstalk phenomenon caused by a strong electric field can be ensured, but the present invention is not limited thereto.

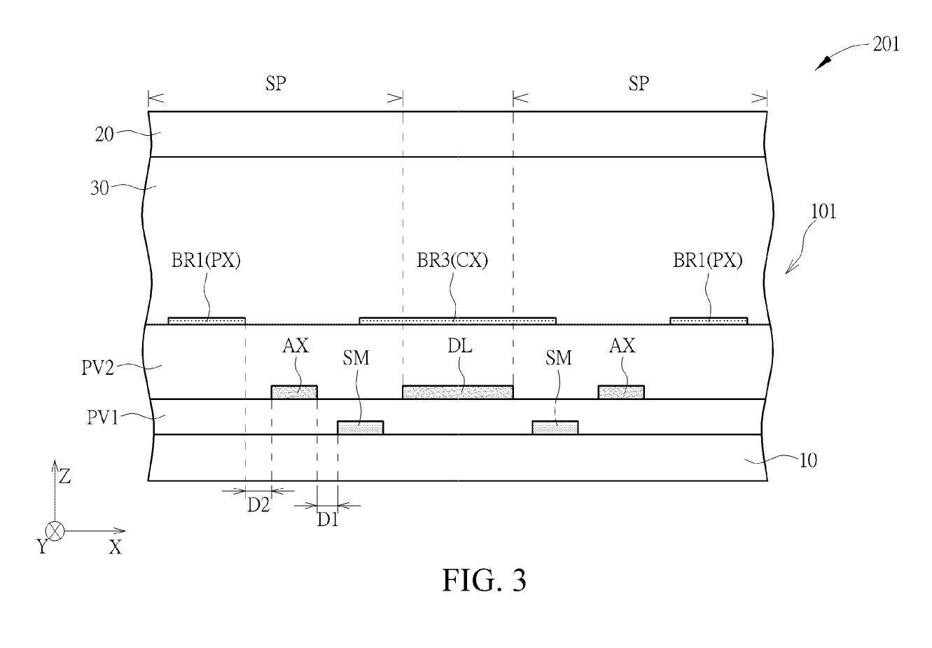

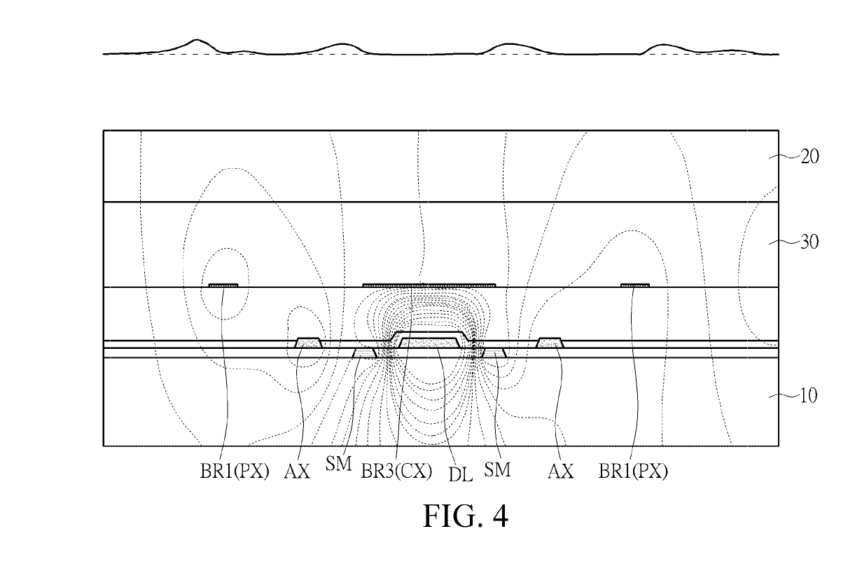

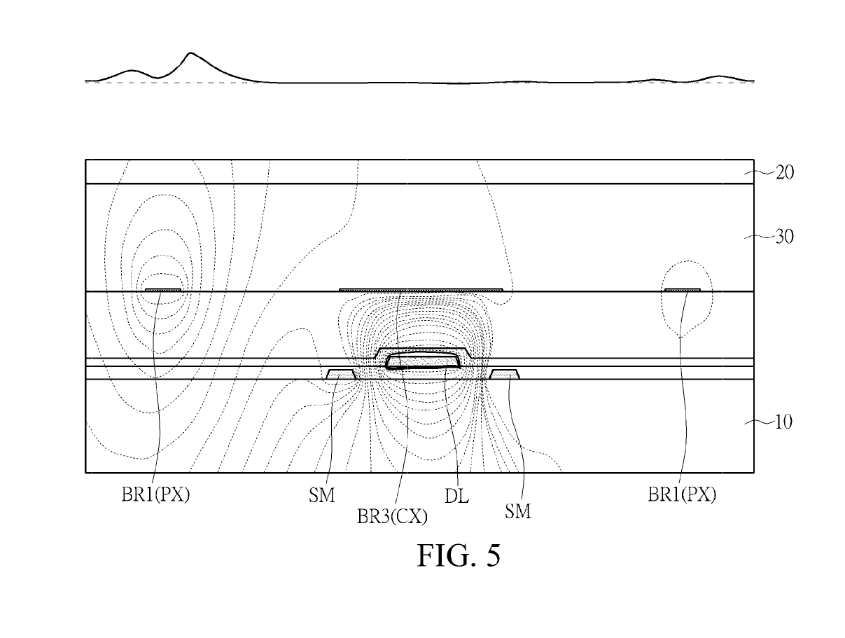

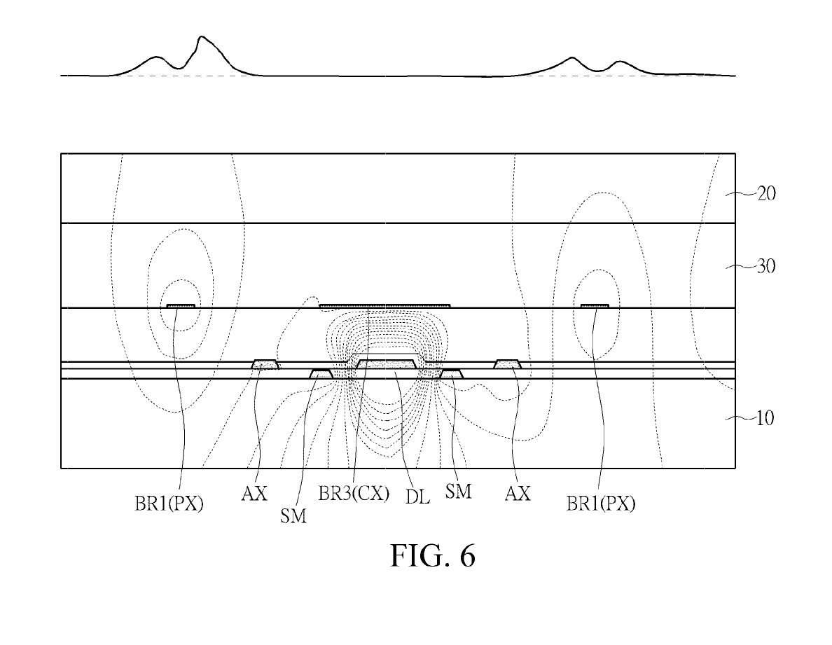

Refer to FIG. 3 to FIG. 6. FIG. 3 shows an IPS liquid crystal display panel according to this embodiment. FIG. 4 is a diagram of brightness distribution of pixel regions on two sides of a data line of an IPS liquid crystal display panel according to a first embodiment of the present invention. FIG. 5 is a diagram of brightness distribution of pixel regions on two sides of a data line of an IPS liquid crystal display panel according to a first comparison example of the present invention. FIG. 6 is a diagram of brightness distribution of pixel regions on two sides of a data line of an IPS liquid crystal display panel according to a second comparison example of the present invention. In FIG. 4 to FIG. 6, a curve drawn above an opposite substrate 20 represents a brightness distribution. As shown in FIG. 3, the IPS liquid crystal display panel 201 in this embodiment includes the foregoing array substrate 101, the opposite substrate 20, and a liquid crystal layer 30. The opposite substrate 20 and the array substrate 101 are disposed opposite, and the liquid crystal layer 30 is disposed between the array substrate 101 and the opposite substrate 20. It should be noted that the array substrate 101 in this embodiment is not limited to being applied to the IPS liquid crystal display panel 201 in this embodiment, that is, the array substrate 101 may also be applied to another type of display panel according to a requirement.

As shown in FIG. 3 to FIG. 6, a difference between the IPS liquid crystal display panel in the first comparison example in FIG. 5 and the IPS liquid crystal display panel 201 in this embodiment lies in that the IPS liquid crystal display panel in the first comparison example does not have the auxiliary electrode AX, and a difference between the IPS liquid crystal display panel in the second comparison example in FIG. 6 and the IPS liquid crystal display panel 201 in this embodiment lies in that the auxiliary electrode AX of the IPS liquid crystal display panel in the second comparison example has a level equal to that of the common electrode CX. Therefore, as shown by results of brightness distribution in FIG. 4 to FIG. 6, in this embodiment, the auxiliary electrode AX that has a level equal to that of the pixel electrode PX can make brightness distribution of pixel regions on two sides of the data line DL be consistent. Otherwise, when the auxiliary electrode AX is not disposed or the auxiliary electrode AX and the common electrode CX do not have equal levels, the brightness distribution of pixel regions on two sides of the data line DL are inconsistent and a crosstalk phenomenon becomes severe.

Different embodiments of the present invention are described below, and to simplify description, the following description mainly focuses on different parts of the embodiments, and same parts are no longer described repeatedly. In addition, the same elements in the embodiments of the present invention are represented by the same reference numerals, so as to facilitate reference among the embodiments.

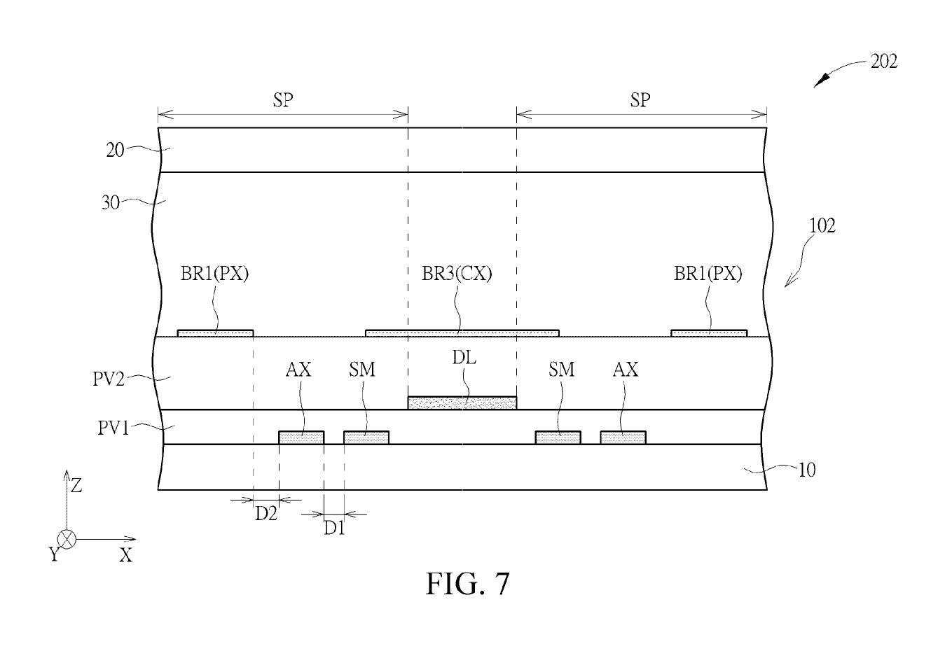

Refer to FIG. 7. FIG. 7 is a schematic view of an array substrate 102 and IPS liquid crystal display panel 202 according to a second embodiment of the present invention. As shown in FIG. 7, a difference between the array substrate 102 in this embodiment and the foregoing first embodiment lies in that the auxiliary electrode AX in the array substrate 102 is on a same plane as the light-shielding pattern SM, and the auxiliary electrode AX and the light-shielding pattern SM may be formed together by using a patterning conductive layer; however, the present invention is not limited thereto. In this embodiment, the first distance D1 of the auxiliary electrode AX in the first direction X from the light-shielding pattern SM is preferably less than the second distance D2 of the auxiliary electrode AX in the first direction X from the first branch electrode BR1.

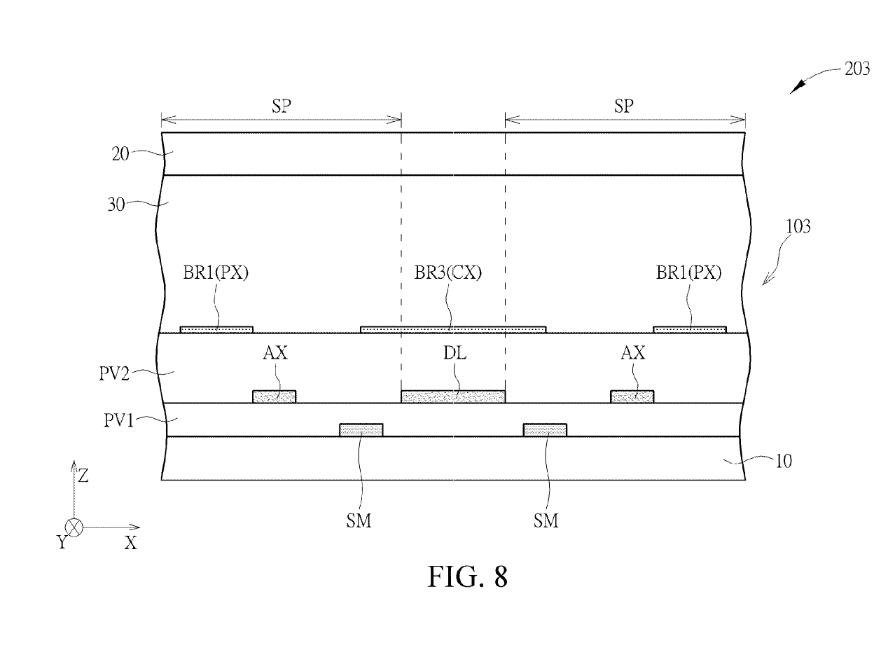

Refer to FIG. 8. FIG. 8 is a schematic view of an array substrate 103 and an IPS liquid crystal display panel 203 according to a third embodiment of the present invention. As shown in FIG. 8, a difference between the array substrate 103 in this embodiment and the foregoing first embodiment lies in that in this embodiment, a distance of the auxiliary electrode AX in the first direction X from the light-shielding pattern SM is greater than a distance of the auxiliary electrode AX in the first direction X from the first branch electrode BR1.

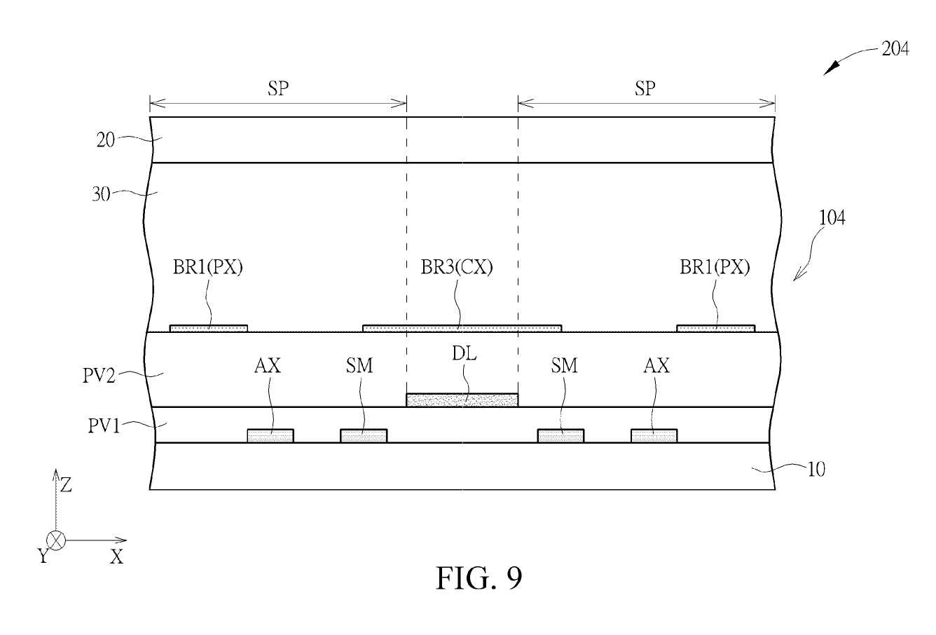

Refer to FIG. 9. FIG. 9 is a schematic view of an array substrate 104 and an IPS liquid crystal display panel 204 according to a fourth embodiment of the present invention. As shown in FIG. 9, a difference between the array substrate 104 in this embodiment and the foregoing second embodiment lies in that in this embodiment, a distance of the auxiliary electrode AX in the first direction X from the light-shielding pattern SM is greater than a distance of the auxiliary electrode AX in the first direction X from the first branch electrode BR1.

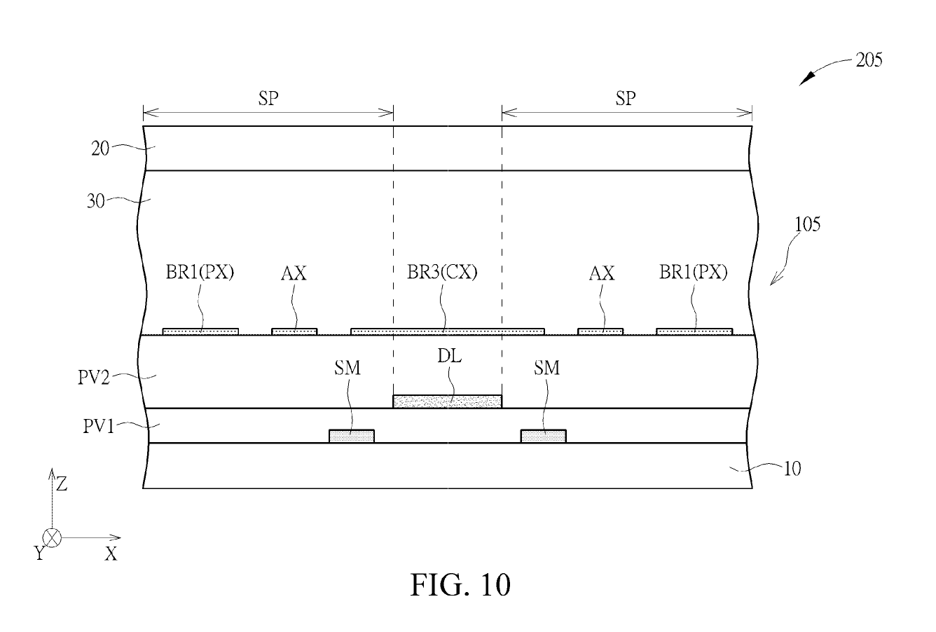

Refer to FIG. 10. FIG. 10 is a schematic view of an array substrate 105 and an IPS liquid crystal display panel 205 according to a fifth embodiment of the present invention. As shown in FIG. 10, a difference between the array substrate 105 in this embodiment and the foregoing first embodiment lies in that in this embodiment, the auxiliary electrode AX is on a same plane as the pixel electrode PX, and the common electrode CX is not disposed between the auxiliary electrode AX and the first branch electrode BR1. The auxiliary electrode AX and the pixel electrode PX may be formed together by using a same patterning transparent conductive layer, and therefore, the auxiliary electrode AX may include a transparent conductive material; however, the present invention is not limited thereto.

In conclusion, in the array substrate and the IPS liquid crystal display panel of the present invention, an auxiliary electrode having a level the same as that of a pixel electrode is disposed between the pixel electrode and a light-shielding pattern, and the auxiliary electrode is used to mitigate a crosstalk phenomenon caused by a strong electric field caused by pixel electrodes and common electrodes in adjacent pixel regions. Further, display quality can be improved.

The foregoing are merely preferred embodiments of the present invention, and any equivalent changes and modifications made according to the claims of the present invention shall fall within the scope of the present invention.

What is claimed is:

1. An array substrate, comprising:
a first substrate;
a plurality of data lines, disposed on the first substrate;
a plurality of gate lines, disposed on the first substrate, wherein at least one pixel region is defined by the data lines and the gate lines crossing with one another;
at least one pixel electrode, disposed on the first substrate and at least partially located in the pixel region, wherein the pixel electrode comprises at least one first branch electrode;
at least one common electrode, disposed on the first substrate and at least partially located in the pixel region, wherein the common electrode comprises at least one second branch electrode, and the first branch electrode and the second branch electrode are disposed alternately in a first direction;
at least one light-shielding pattern, disposed on the first substrate and at least partially located in the pixel region, wherein the light-shielding pattern is disposed between a first data line adjacent to the pixel region and the first branch electrode in the first direction; and
at least one auxiliary electrode, disposed on the first substrate and at least partially located in the pixel region, wherein the auxiliary electrode is at least partially located between the first branch electrode and the light-shielding pattern in the first direction, and the auxiliary electrode is electrically connected to the pixel electrode.

2. The array substrate according to claim 1, wherein both the pixel electrode and the common electrode are on a first plane, and the light-shielding pattern is on a second plane, wherein the first plane is different from the second plane.

3. The array substrate according to claim 1, wherein the auxiliary electrode in the first direction is closer to the light-shielding pattern than to the first branch electrode.

4. The array substrate according to claim 1, wherein the auxiliary electrode is on a first plane, and the pixel electrode and the light-shielding pattern are on a second plane, wherein the first plane is different from the second plane.

5. The array substrate according to claim 4, wherein the plurality of data lines are on the first plane.

6. The array substrate according to claim 1, wherein the auxiliary electrode and the light-shielding pattern are on a first plane.

7. The array substrate according to claim 1, wherein the auxiliary electrode and the pixel electrode are on a first plane, and the common electrode is not disposed between the auxiliary electrode and the first branch electrode.

8. The array substrate according to claim 1, wherein the auxiliary electrode is not completely overlapped with the pixel electrode, with the light-shielding pattern, or with both the pixel electrode and the light-shielding pattern in a vertical direction of the first substrate.

9. The array substrate according to claim 1, wherein the light-shielding pattern is electrically connected to the common electrode.

10. The array substrate according to claim 1, wherein the common electrode further comprises a third branch electrode disposed corresponding to the first data line adjacent to the pixel region, and the third branch electrode is partially overlapped with the first data line in a vertical direction of the first substrate.

11. The array substrate according to claim 1, wherein the auxiliary electrode comprises a metal or transparent conductive material.

12. The array substrate according to claim 1, further comprising at least one control element disposed on the first substrate and at least partially located in the pixel region, wherein the pixel electrode and the auxiliary electrode are electrically connected to a drain of the control element respectively to have a same level.

13. An in-plane switching (IPS) liquid crystal display panel, comprising:
an array substrate, comprising:
a first substrate;
a plurality of data lines, disposed on the first substrate;
a plurality of gate lines, disposed on the first substrate, wherein at least one pixel region is defined by the data lines and the gate lines crossing with one another;
at least one pixel electrode, disposed on the first substrate and at least partially located in the pixel region, wherein the pixel electrode comprises at least one first branch electrode;
at least one common electrode, disposed on the first substrate and at least partially located in the pixel region, wherein the common electrode comprises at least one second branch electrode, and the first branch electrode and the second branch electrode are disposed alternately in a first direction;
at least one light-shielding pattern, disposed on the first substrate and at least partially located in the pixel region, wherein the light-shielding pattern is disposed between a first data line adjacent to the pixel region and the first branch electrode in the first direction; and
at least one auxiliary electrode, disposed on the first substrate and at least partially located in the pixel region, wherein the auxiliary electrode is at least partially located between the first branch electrode and the light-shielding pattern in the first direction, and the auxiliary electrode is electrically connected to the pixel electrode;
an opposite substrate, disposed opposite the array substrate; and
a liquid crystal layer, disposed between the array substrate and the opposite substrate.
